(19) United States
(12) Patent Application Publication
(10) Pub. No.: US 2015/0086700 A1
(43) Pub. Date: Mar. 26, 2015

(54) CREAMER COMPOSITION COMPRISING PROTEIN AND HYDROXYPROPYL STARCH

(71) Applicant: NESTEC S.A., Vevey (CH)

(72) Inventors: Christine Ann Beeson, Marysville, OH (US); Alexander A. Sher, Dublin, OH (US)

(21) Appl. No.: 14/390,873

(22) PCT Filed: Mar. 25, 2013
(86) PCT No.: PCT/EP13/56240

§ 371 Date: Oct. 6, 2014

Related U.S. Application Data
(60) Provisional application No. 61/620,242, filed on Apr. 4, 2012.

(51) Int. Cl. A23C 11/08; A23L 2/58

(52) U.S. Cl. CPC A23C 11/08; A23L 2/58; A23V 2002/00
USPC 426/593; 426/656; 426/519; 426/590; 426/594; 426/597

(57) ABSTRACT

The present invention relates to a creamer composition, e.g. for use for addition into a coffee beverage, having good physical stability without the need for low molecular emulsifiers. The creamer comprises protein and hydroxypropyl starch. The invention further relates to a method of producing the creamer, a beverage composition comprising the creamer, and a method of producing a beverage composition.

### FIELD OF THE INVENTION

The present invention relates to creamers that may be used e.g. for adding to coffee, tea, and cocoa beverages, and to methods of producing creamers.

### BACKGROUND

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Emulsions and suspensions are not thermodynamically stable, and there is a real challenge to overcome physico-chemical instability issues in the liquid creamers that contain oil and other insoluble materials, especially for the aseptic liquid creamers during long storage times at ambient or elevated temperatures. Moreover, over time, creaming that can still be invisible in the liquid beverages stored at room and elevated temperatures can cause a plug in the bottle when refrigerated. Conventionally, low molecular emulsifiers, such as e.g. mono- and diglycerides, are added to non-dairy liquid creamers to ensure stability of the oil-in-water emulsion. Low molecular weight emulsifiers are effective stabilisers of the oil-in-water emulsion, but may be perceived as artificial by consumers. Hydrocolloids such as kappa-carragenan, iota-carragenan, and/or lambda-carragenan; starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof may be used in liquid creamers to obtain desired mouthfeel and viscosity but have not been shown to produce sufficient emulsion stability to replace low molecular emulsifiers.

Modified starches are normally used in products where a high viscosity and a high degree of texture is desired, e.g. in instant desserts, pizza toppings, frozen foods, ice-cream, frozen cakes, dry mixes (cupcakes, muffins, cakes, cookies, self-saucing puddings), flavoured toppings and sauces, mayonnaises, snacks and muesli bars, and gravies.

In view of the previous discussion, there are numerous challenges in creating a liquid creamer without low molecular emulsifiers, which is homogeneous, shelf-stable, and shows good physical stability.

### SUMMARY OF THE INVENTION

The inventors have surprisingly found that hydroxypropyl starch can be used to replace low molecular emulsifiers in liquid creamers, and provide a good physical stability without excessive viscosity. Accordingly, the present invention relates to a creamer composition comprising protein and hydroxypropyl starch. In further embodiments, the invention relates to a method of producing a creamer composition of the invention as well as a method of preparing a beverage composition.

### DETAILED DESCRIPTION OF THE INVENTION

According to the present invention a creamer composition is provided which has a good physical stability without the need for low molecular emulsifiers. By physical stability is meant stability against phase separation, plug formation, flocculation and/or aggregation of fat due to fat crystallization and/or formation of an oil rich fraction in the upper part of the composition due to aggregation and/or coalescence of oil droplets, e.g. aggregation and/or coalescence of oil droplets to form a hard “plug” in the upper part of the product.

By a creamer composition is meant a composition that is intended to be added to a food composition, such as e.g. coffee or tea, to impart specific characteristics such as colour (e.g. whitening effect), thickening, flavour, texture, and/or other desired characteristics. A creamer composition of the invention is preferably in liquid form, but may also be in powdered form.

The creamer composition of the invention comprises hydroxypropyl starch. Hydroxypropyl starch is a derivative of natural starch. Linear and branched carbohydrate polymers in natural starch have three reactive OH groups on each glucose unit. During manufacture of hydroxypropyl starch, these polymers are reacted with propylene oxide, adding hydroxypropyl (CH(OH)CH₂CH₃) groups at the OH positions by an ether linkage. Modification is usually carried out by propylene oxide at levels up to 25% and the resultant starch is often lightly oxidized, bleached or acid modified after etherification. Substitution normally amounts to a maximum of 40 ether linkages per 100 glucopyranose units if 25% propylene oxide is used, and 4-6 ether linkages per 100 glucopyranose units if 5% propylene oxide is used.

Hydroxypropyl starch is preferably present in the creamer composition of the invention in an amount of between about 2% and about 10% (weight/weight), such as between about 3% and about 9%, more preferably between about 4% and about 8%. If too little hydroxypropyl starch is used, the physical stability of the liquid creamer composition is reduced, and phase separation may occur. At high levels of hydroxypropyl starch the viscosity may become higher than desired in a liquid creamer, and processing may become difficult.

The creamer composition of the invention further comprises protein, preferably between about 0.1% (weight/weight) and about 3% protein, such as between about 0.2% (weight/weight) and about 2% protein, more preferably between about 0.5% (weight/weight) and about 1.5% protein. The protein may be any suitable protein, e.g. milk protein, such as casein, caseinate, and whey protein; vegetable protein, e.g. soy and/or pea protein; and/or combinations thereof. The protein is preferably sodium caseinate. The protein in the composition may work as an emulsifier, provide texture, and/or provide whitening effect. Too low levels of protein may reduce the stability of the liquid creamer and creaming may occur. At high protein levels phase separation may occur.

The weight ratio between protein and hydroxypropyl starch is preferably between about 1:0.7 and about 1:50, such as between about 1:2 and about 1:20, more preferably between about 1:4 and about 1:15.

In one embodiment of the invention, the creamer composition is devoid of added low molecular weight emulsifiers. By a low molecular weight emulsifier is meant an emulsifier with a molecular weight below 1500 g/mol Emulsions are thermodynamically unstable, and the phases of an emulsion will separate with time. By an emulsifier is meant a compound that stabilises the interface between the two phases of the oil-in-water emulsion and reduces the rate of phase separation. By the term “devoid of added low molecular emulsifiers” is meant that the creamer composition does not contain any low molecular emulsifiers which have been added in amounts sufficient to substantially affect the stability the emulsion. A creamer composition devoid of added low molecular emulsifiers may contain minor amounts of low molecular emulsifiers which do not substantially affect the stability of the emulsion, but which are present e.g. as minor impurities of one or more of the ingredients of the creamer composition.

Low molecular weight emulsifiers include, but are not limited to, monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and diglycerides, lecithins, lysolecitins, and sucrose esters of fatty acids.

In one embodiment a creamer composition according to the invention is devoid of added monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and/or diglycerides, and sucrose esters of fatty acids.

In a further embodiment of the invention, the creamer composition is devoid of added lecithin and lysolecithins, indcluding lecithin and/or lysolecithin derived from soy, canola, sunflower, and/or safflower.

In one embodiment, the creamer composition of the invention comprises oil. The oil may be any oil, or combination oils, suitable for use in a liquid creamer. The oil is preferably a vegetable oil, such as e.g. oil from canola, soy bean, sunflower, safflower, cotton seed, palm oil, palm kernel oil, corn, and/or coconut. The oil is preferably present in an amount of at most about 20% (weight/weight), the amount of oil in the creamer composition may e.g. be between about 1% and about 20% (weight/weight), such as between about 2% and about 10%. In another embodiment, the creamer composition of the invention is oil free.

The creamer composition of the present invention may further include a buffering agent. The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 1% by weight of the liquid creamer.

The creamer composition of the present invention may further include one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5% to about 40% by weight. In another embodiment, the sweetener concentration ranges from about 25% to about 30% by weight.

The invention further relates to a method of producing a creamer composition of the invention. The method comprises providing a composition, the composition comprising water, protein and hydroxypropyl starch, and optionally additional ingredients as disclosed herein; and homogenising the composition to produce a creamer composition. Before homogenisation, optional compounds such as, hydrocolloids, buffers, sweeteners and/or flavors may be hydrated in water (e.g., at between 40° C. and 90° C.) under agitation, with addition of melted oil if desired. The method may further comprise heat treating the composition before homogenisation, e.g. by aseptic heat treatment. Aseptic heat treatment may e.g. use direct or indirect UHT processes. UHT processes are known in the art. Examples of UHT processes include UHT sterilization and UHT pasteurization. Direct heat treatment can be performed by injecting steam into the emulsion. In this case, it may be necessary to remove excess water, for example, by flashing. Indirect heat treatment can be performed with a heat transfer interface in contact with the emulsion. The homogenization may be performed before and/or after heat treatment. It may be advantageous to perform homogenization before heat treatment if oil is present in the composition, in order to improve heat transfers in the emulsion, and thus achieve an improved heat treatment. Performing a homogenization after heat treatment usually ensures that the oil droplets in the emulsion have the desired dimension. After heat treatment the product may be filled into any suitable packaging, e.g. by aseptic filling. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. 6,536,188 to Taggart, which are incorporated herein by reference. In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono-and di-phosphates, potassium mono-and di-phosphates, sodium mono- and bi-carbonates, potassium mono- and bi-carbonates or a combination thereof.

The creamer, when added to a beverage, produces a physically stable, homogeneous, whitened drink with a good mouthfeel, and body, smooth texture, and a pleasant taste with no off-flavors notes. The use of the creamer of the invention is not limited for only coffee applications. For example, the creamer can be also used for other beverages, such as tea or cocoa, or used with cereals or berries, as a creamer for soups, and in many cooking applications, etc. A liquid creamer of the invention is preferably physically stable and overcome phase separation issues (e.g., creaming, plug formation, gelation, syneresis, sedimentation, etc.) during storage at refrigeration temperatures (e.g., about 4° C.), room temperatures (e.g., about 20° C.) and elevated temperatures (e.g., about 30 to 38° C.). The stable liquid creamers can have a shelf-life stability such as at least 6 months at 4° C. and/or at 20° C., 6 months at 30° C., and 1 month at 38 ° C. Stability may be evaluated by visual inspection of the product after storage.

The invention in an even further aspect relates to a beverage composition comprising a creamer composition as disclosed above. A beverage composition may e.g. be a coffee, tea, malt, cereal or cocoa beverage. A beverage composition may be liquid or in powder form. Accordingly, the invention relates to a beverage composition comprising a) a creamer composition of the invention, and b) a coffee, tea, malt, cereal, or cocoa product, e.g. an extract of coffee, tea, malt, or cocoa. If the beverage composition is in liquid form it may e.g. be packaged in cans, glass bottles, plastic bottles, or any other suitable packaging. The beverage composition may be aseptically packaged. The beverage composition may be produced by a method comprising a) providing a beverage composition base; and b) adding a creamer composition according to the invention to the beverage composition base. By a beverage composition base is understood a composition useful for producing a beverage by addition of a creamer of the invention. A beverage composition base may in itself be suitable for consumption as a beverage. A beverage composition base may e.g. be an extract of coffee, tea, malt, or cocoa.

A liquid creamer of the invention has good whitening capacity and is also stable (without feathering, de-oiling, other phase separation defects) when added to hot beverages (coffee, tea and like), even when coffee is made with hard water, and also provides good mouthfeel

### EXAMPLES

By way of example and not limitation, the following examples are illustrative of various embodiments of the present disclosure.

### Example 1

A dry blend of 6 kg of hydroxypropyl starch, 60 g of flavor, 900 g of sodium caseinate and 500 g of di-potassium phosphate, was added into 88 kg of hot water (˜65° C.) under high continuous agitation.

After ˜10 minutes of mixing, 6.8 kg of canola oil was added under high agitation. A small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles and stored for 7 months at 4° C., and also at room temperature and elevated temperatures.

The physico-chemical stability and sensory characteristics of the liquid creamer and coffee beverages with added liquid creamer were judged by sensory panelists. No phase separation (creaming, de-oiling, marbling, etc), gelation, and practically no viscosity changes were found during the storage.

It was found that the liquid creamer without low molecular weight emulsifier had good appearance, mouth-feel, smooth texture and a good flavor without “off”-taste. In addition, the creamer showed high whitening capacity when added to a coffee.

### Example 2

A dry blend of 6 kg of hydroxypropyl starch, 60 g of flavor, 900 g of sodium caseinate and 500 g of di-potassium phosphate was added into 88 kg of hot water (˜65° C.) under high continuous agitation.

After ˜10 minutes of mixing, low molecular weight emulsifiers (100 g of Dimodan (monoglycerides) and 300 g of Panodan (diacetylated tartaric acid esters of monoglycerides)) were added into the tank under continuous high agitation. After 5 minutes of mixing, 6.8 kg of canola oil was added under high agitation. A small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles. The physico-chemical stability and sensory characteristics of the liquid creamer and coffee beverages with added liquid creamer were judged. Creaming and phase separation was observed. Storage protocol was 1 month at 38° C., 3 months at 30 ° C. and 9 months at 20 and 4° C. Creaming and phase separation was observed after two months storage at 4° C.

### Example 3

A liquid creamer composition was prepared as in Example 1 but using 11 kg of hydroxypropyl starch. It was found that viscosity of the creamer was unacceptable for the processing conditions due to extremely high viscosity values.

### Example 4

A liquid creamer composition was prepared as in Example 1 but using 1.5 kg of hydroxypropyl starch. It was found that product became unstable (phase separation).

### Example 5

A liquid creamer composition was prepared as in Example 1 but without oil. It was found that the product was stable.

### Example 6

A liquid creamer composition was prepared as in Example 1 but with 20 kg oil. It was found that the product was stable.

### Example 7

A liquid creamer composition was prepared as in Example 1 but with 22 kg oil. It was found that the product became unstable (creaming).

### Example 8

A liquid creamer composition was prepared as in Example 1 but with 0.1 kg sodium caseinate. It was found that the product became unstable (creaming).

### Example 9

A liquid creamer composition was prepared as in Example 1 but with 3.5 kg sodium caseinate. It was found that product became unstable (serum separation).

### Example 10

Liquid creamer compositions were prepared as in example 1, except that the hydroxypropyl starch was substituted with different ingredients and the amount of water was adjusted accordingly to obtain 100 kg of product. Results for the different ingredients are shown in Table 1.

TABLE 1

| | Amount (% | | |
|---|---|---|---|
| Ingredient | weight/weight) | | |
| Lamba Carrageenan, | 1 | Not stable | extremely high |
| GP 109, FMC | | | viscosity |
| Gum Arabic, FT, | 6 | Not stable | |
| Frutarom | | | |
| Sodium octenyl | 6 | Not stable | serum and |
| succinate waxy maize | | | creaming |
| starch, Tate & Lyle | | | |
| Tapioca based starch, | 6 | Not stable | extremely high |
| National starch | | | viscosity |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A creamer composition comprising protein and hydroxypropyl starch.

2. The creamer composition of claim 1 comprising between about 2% and about 10% hydroxypropyl starch.

3. The creamer composition of any of claim 1 comprising between about 0.1% and about 3% protein.

4. The creamer composition of claim 1, wherein the weight ratio of protein and hydroxypropyl starch is between about 1:0.7 and about 1:50.

5. The creamer composition of claim 1 comprising oil.

6. The creamer composition of claim 1 comprising between about 1% and about 20% oil.

7. The creamer composition of claim 1 being devoid of added low molecular weight emulsifiers.

8. The creamer composition of claim 1 being devoid of added monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and/or diglycerides, and sucrose esters of fatty acids.

9. The creamer composition of claim 1 being devoid of added lecithins and lysolecithins.

10. A beverage composition comprising a creamer composition comprising protein and hydroxypropyl starch.

11. The beverage composition of claim 10, wherein the beverage is selected from the group consisting of a coffee, tea, malt, cereal, and cocoa beverage composition.

12. A method of producing a creamer composition comprising:
providing a composition comprising water, protein and hydroxypropyl starch; and
homogenising the composition to produce creamer composition.

13. A method of preparing a beverage composition, the method comprising:
providing a beverage composition base; and
adding a creamer composition comprising protein and hydroxypropyl starch to the beverage composition base.

14. The method of claim 13 wherein the beverage composition is selected from the group consisting of a coffee, tea, malt, cereal, and cocoa beverage.

15. A beverage composition obtainable by the method of claim 13.
